(19) United States
(12) Patent Application Publication
(10) Pub. No.: US 2007/0128347 A1
(43) Pub. Date: Jun. 7, 2007

(54) METHOD FOR PREPARING THIN FILM AND METHOD FOR MANUFACTURING ELECTRON-EMITTING DEVICE

(75) Inventor: RYOJI KONDO, SAGAMIHARA-SHI (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/563,929

(22) Filed: Nov. 28, 2006

(30) Foreign Application Priority Data
Dec. 6, 2005 (JP) 2005-351575

(51) Int. Cl. B05D 5/12; B05D 3/02; B05D 3/10

(52) U.S. Cl. 427/66; 427/379; 427/336

(57) ABSTRACT

To provide a method of forming a thin film comprising steps of: applying on a substrate a liquid containing a component for forming a thin film; drying the liquid to form a precursor of the thin film; and heating the precursor to form the thin film, wherein the heating step is conducted after absorbing into the precursor vapor of water or an organic compound.

### BACKGROUND OF THE INVENTION

1. Field of the Invention

The present invention relates to a method for preparing a thin film which can be used in manufacturing, for instance, a filmy component or a filmy color filter in an electron-emitting device, an organic electroluminescent device and the like, and to a method for manufacturing an electron-emitting device and the like by using the same.

2. Related Background Art

Conventionally, a method of using an ink jet method, which is shown in Japanese Patent Application Laid-Open No. H09-69334 as well, has been known as a method for manufacturing an electron-emitting device.

Specifically, the well-known manufacturing method includes the steps of: applying droplets containing a component for forming the electroconductive thin film between facing device electrodes on a substrate according to an ink jet method; drying the droplets to prepare a precursor of an electroconductive thin film; and subsequently heat-treating (baking) the precursor of the electroconductive thin film to form the electroconductive thin film lying astride the device electrodes. The formed electroconductive thin film is subsequently subjected to the treatment of energizing the device electrodes, which is referred to as a forming process, and a fissure of an electron-emitting region is formed in the electroconductive thin film. After the fissure has been formed, electrons can fly out from the fissure or the vicinity of the fissure, when voltage is applied between the device electrodes. Normally, a surface conduction electron-emitting device can be obtained by subjecting the substrate to the forming process, and thereafter to activation operation and/or stabilization operation.

It is known that the droplets are applied in an atmosphere having a humidity kept at 70% or lower, in a method for manufacturing an electron-emitting device accompanied by the preparation of an electroconductive thin film by applying the above described droplets, which is shown in Japanese Patent Application Laid-Open No. H10-3851. It is thought that the atmosphere inhibits diameters of the droplets from varying due to the bleeding of the droplets and can improve the uniformity and reproducibility of the obtained electroconductive thin film.

However, a droplet applied onto a substrate forms a cross-sectional shape having the height which is highest in the central part due to the surface tension and gets lower toward the periphery. The cross-sectional shape of the electroconductive thin film even obtained by the droplet has a shape having the periphery thinned, which causes a problem that a fissure is hardly formed in an extremely thin region in the periphery, when the fissure of an electron-emitting region is formed by energization treatment. In other words, the known method has a problem that a formed fissure does not completely transverse the electroconductive thin film and tends to leave the region having no fissure formed in an end of the fissure. The region having no fissure formed results in increasing an ineffective leakage current (leak current) which does not contribute to electron emission. When such an electron-emitting device is used in a structure of a picture display unit, the increase of the above leak current increases a load on a driving circuit and causes an image defect due to voltage drop.

The technology described in Japanese Patent Application Laid-Open No. H10-3851 makes the shape of a droplet neat and provides an electroconductive thin film with a uniform shape with adequate reproducibility, but it mainly makes the planar shape into an appropriate form and does not arrange the cross-sectional shape of the electroconductive thin film obtained from the above described droplet into an appropriate form. Accordingly, the technology can not fundamentally solve a problem that the fissure is hardly formed in an extremely thin region in the periphery of the above described electroconductive thin film.

In addition, the above described extremely thin region of the periphery causes variations in microscopic shapes in a thin film other than the electroconductive thin film in an electron-emitting device, and may cause various problems.

### SUMMARY OF THE INVENTION

An object of the present invention is to adjust appropriately a shape and a thickness of a peripheral edge of a thin film on a substrate when thin film is formed by applying droplets containing a component for forming the thin film onto the substrate, drying it and heat-treating it.

Another object of the present invention is to make easy manufacturing of an electron-emitting device with a small amount of a leak current.

The present invention provides a method for preparing a thin film comprising the steps of: applying a liquid containing a component for forming a thin film onto a substrate; drying the liquid to form a precursor of the thin film; and heating the precursor to form the thin film, wherein the heating step is conducted after absorbing of the vapor of water or organic compound into the precursor of the thin film.

The present invention also provides a method for manufacturing an electron-emitting device comprising steps of: applying a liquid containing a component for forming an electroconductive thin film on a substrate; drying the liquid to form a precursor of the electroconductive thin film; and heating the precursor of the electroconductive thin film to form the electroconductive thin film; and forming an electron-emitting region in the electroconductive thin film, wherein the heating step is conducted after a step of making the precursor of the electroconductive thin film absorb the vapor of water or organic compound.

Further features of the present invention will become apparent from the following description of exemplary embodiments (with reference to the attached drawings).

### BRIEF DESCRIPTION OF THE DRAWING

FIGS. 1A and 1B are schematic block diagrams showing a configuration of a surface conduction electron-emitting device which can be manufactured by the present invention, and FIG. 1A shows a plan view and FIG. 1B shows a view of a section in a line 1B-1B of FIG. 1A.

FIG. 2 is an explanatory drawing on a liquid application mechanism for applying a liquid containing a component for forming an electroconductive thin film onto a substrate by an ink jet method.

FIG. 3 is an explanatory drawing of an absorbing device for making a precursor of an electroconductive thin film formed by applying a liquid onto a substrate and drying it absorb the vapor of water or organic compound.

FIGS. 4A and 4B are explanatory drawings on an operation of arranging a periphery shape of the precursor of an electroconductive thin film into an appropriate form by making the precursor absorb the vapor of water or organic compound.

FIG. 4A is an explanatory drawing of the cross-sectional shape of the precursor of the electroconductive thin film formed by applying a liquid onto a substrate and only drying it.

FIG. 4B is an explanatory drawing on the cross-sectional shape of a precursor of an electroconductive thin film formed by steps of: applying a liquid onto a substrate, drying it and further making it absorb the vapor of water or organic compound in an atmosphere in which a partial pressure of the vapor is lower than the saturated vapor pressure.

FIGS. 5A and 5B are explanatory drawings on an operation of arranging the whole shape of the precursor of an electroconductive thin film into an appropriate form by making the precursor absorb the vapor of water or organic compound.

FIG. 5A is an explanatory drawing on an example of a cross-sectional shape of a precursor of an electroconductive thin film formed by applying a liquid onto a substrate and only drying it.

FIG. 5B is an explanatory drawing on a cross-sectional shape of the precursor of an electroconductive thin film by steps of: applying a liquid onto a substrate, drying it and further making it absorb the vapor of water or organic compound in an atmosphere in which a partial pressure of the vapor is close to the saturated vapor pressure.

FIG. 6 is a diagrammatic plan view of an electron source substrate manufactured in Embodiments.

### DETAILED DESCRIPTION OF THE EMBODIMENTS

The present invention provides a method for preparing a thin film comprising the steps of: applying a liquid containing a component for forming a thin film onto a substrate; drying the liquid to form a precursor of the thin film; and heating the precursor to form the thin film, wherein the heating step is conducted after a step of making the precursor of the thin film absorb the vapor of water or organic compound.

The present invention also provides a method for manufacturing an electron-emitting device comprising steps of: applying a liquid containing a component for forming an electroconductive thin film on a substrate; drying the liquid to form a precursor of the electroconductive thin film; and heating the precursor of the electroconductive thin film to form the electroconductive thin film; and forming an electron-emitting region in the electroconductive thin film, wherein the heating step is conducted after a step of making the precursor of the electroconductive thin film precursor absorb the vapor of water or organic compound.

In the present invention, the absorption of the vapor means the absorption of water or an organic compound contained in the air. The above described organic compound is preferably an organic solvent used in a liquid containing a component for forming a thin film.

### (Effects of the Invention)

The method for preparing a thin film according to the present invention can greatly reduce an extremely thin film region which tends to form on a perimeter of the thin film, by making the precursor of the thin film formed by drying a liquid absorb the vapor of water or organic compound, and accordingly can provide the thin film having an appropriate shape microscopically as well.

In addition, when the method for preparing a thin film according to the present invention is used for forming an organic light-emitting thin-film in an organic electroluminescent device or a light transmissive thin film in a color filter, the method greatly reduces variations in the shape among the obtained thin films, and can greatly reduce variations of light-emitting properties and light transmissive characteristics among the thin films.

Furthermore, when the method for preparing a thin film according to the present invention is used for forming an electron-emitting thin film in an electron-emitting device, the method greatly reduces variations of the shape among obtained thin films, and can greatly reduce variations of electron-emitting properties among the thin films.

Furthermore, when the method for preparing a thin film according to the present invention is used for forming an electroconductive thin film of an electron-emitting device in which the electron-emitting region is formed by energization treatment as described above, the method can greatly reduce an extremely thin film region which tends to form on a perimeter of the obtained electroconductive thin film; and can provide an electron-emitting device causing little leak current because the method can prevent no fissure region from forming due to the extremely thin film region. Accordingly, when the electron-emitting device obtained according to the present invention is used in a picture display unit, the device can provide the picture display unit which gives a small load on a driving circuit and hardly produces an image defect due to voltage drop.

In the next place, the present invention will be described with reference to the case of forming an electroconductive thin film used when manufacturing a surface conduction electron-emitting device.

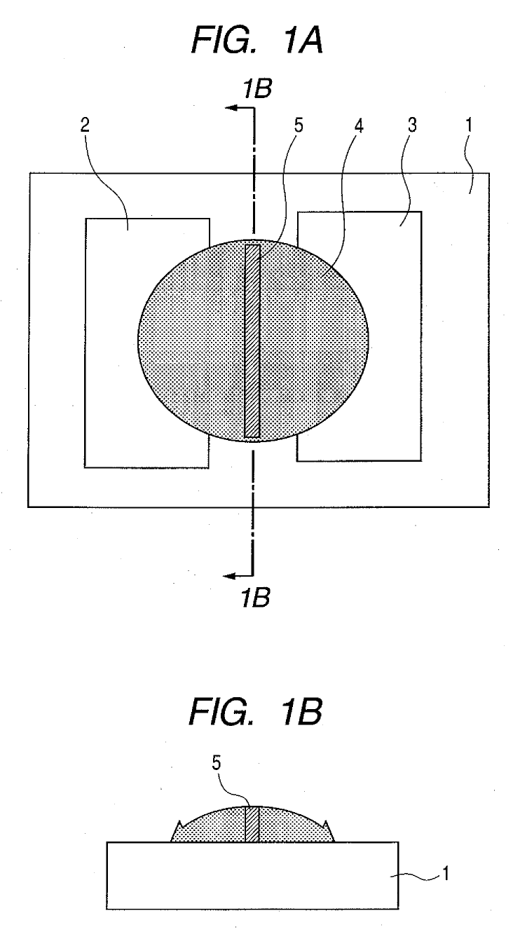

FIGS. 1A and 1B are schematic block diagrams showing a configuration of a surface conduction electron-emitting device which can be manufactured by the present invention, and FIG. 1A shows a plan view and FIG. 1B shows a view of a section in a line 1B-1B of FIG. 1A.

In the above described FIGS. 1A and 1B, reference numeral 1 denotes a substrate, reference numerals 2 and 3 denote device electrodes, reference numeral 4 denotes an electroconductive thin film and reference numeral 5 denotes an electron-emitting region (fissure).

A usable substrate 1 includes quartz glass, glass containing a reduced impurity content such as Na decreased, soda lime glass, a stacked sheet of soda lime glass with a SiO₂ film stacked thereon by a sputtering method, and a ceramic sheet such as an alumina sheet.

A usable material for device electrodes 2 and 3 to be arranged on a substrate 1 is a general electroconductive material. The material includes, for instance, a metal such as Ni, Cr, Au, Mo, W, Pt, Ti, Al, Cu and Pd; an alloy thereof; and a metal such as Pd, As, Ag, Au, RuO₂ and Pd—Ag. The material can also be appropriately selected from a printed conductor consisting of a metallic oxide and glass, a transparent conductor such as In2O3—SnO2, a semiconductor material such as polysilicon and the like.

A distance between device electrodes 2 and 3, lengths of the device electrodes 2 and 3, and a shape of an electroconductive thin film 4 can be appropriately designed according to a field of use of an obtained electron-emitting device.

The distance between device electrodes 2 and 3 is preferably from several thousands of angstroms to several hundreds of micrometers, and further preferably is in a range of 1 μm to 100 μm in consideration of voltage to be applied between the device electrodes 2 and 3. The lengths of the device electrodes 2 and 3 are preferably in a range of several micrometers to several hundreds of micrometers in consideration of an ohmic value and electron emission characteristics of the electrodes. Furthermore, the film thickness of the device electrodes 2 and 3 are preferably several hundreds of angstroms to several micrometers, and further preferably is in a range of 100 Å to 1 μm.

In FIGS. 1A, device electrodes 2 and 3 and an electroconductive thin film 4 are sequentially stacked on a substrate 1 in that order, but the electroconductive thin film 4 and the device electrodes 2 and 3 can be stacked on the substrate 1 in that order as well.

An electroconductive thin film 4 is a thin film that has electroconductivity and is prepared by a method according to the present invention, which will be described later. A material composing the electroconductive thin film 4 includes, for instance, metals such as Pd, Pt, Ru, Ag, Au, Ti, In, Cu, Cr, Fe, Zn, Sn, Ta, W and Pb; and metallic oxides such as PdO, SnO2, In2O3, PbO and Sb2O3. The material can also include: metal borides such as HfB2, ZrB2, LaB6, CeB6, YB4 and GdB4; metal nitrides such as TiN, ZrN and GfN; metal carbides such as TiC, ZrC, GfC, TaC, SiC and WC; semiconductors such as Si and Ge; and carbon.

An electron-emitting region 5 is a fissure which is formed in one part of an electroconductive thin film 4, has high resistance and is formed in consideration of a material, film quality and film thickness of the electroconductive thin film 4, and a manufacturing method such as energization forming. The electron-emitting region 5 may contain electroconductive fine particles with a particle size of 1,000 Å or less inside it. The electroconductive fine particle contains the same elements as some or all of the elements in the material composing the electroconductive thin film 4. The electroconductive thin film 4 in an electron-emitting region 5 and the vicinity occasionally contains carbon or a carbon compound as well.

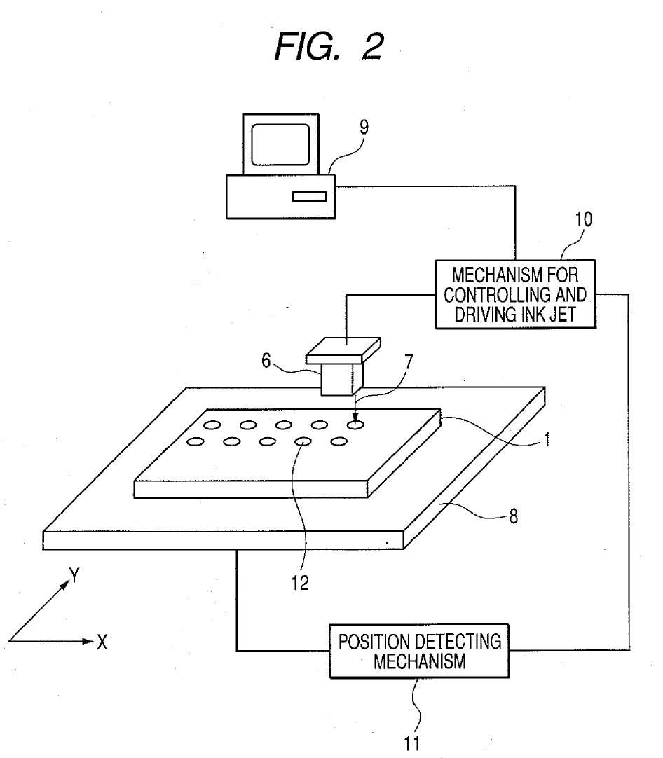

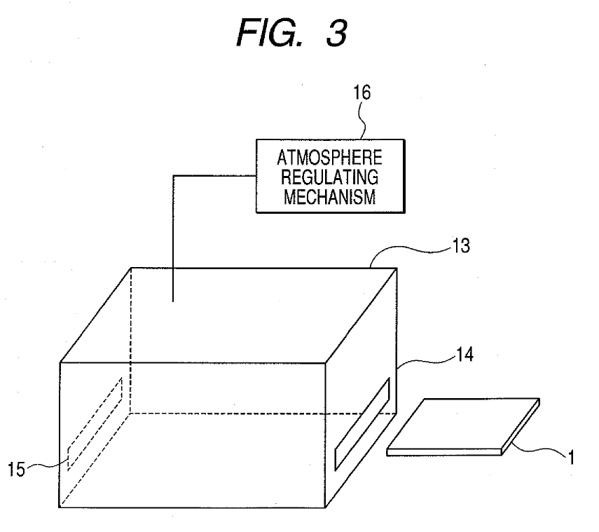

In the next place, a method for preparing an electroconductive thin film 4 in the above described surface conduction electron-emitting device will be described with reference to FIG. 2 and FIG. 3.

FIG. 2 is an explanatory drawing for a liquid application mechanism for applying a liquid containing a component for forming an electroconductive thin film onto a substrate by an ink jet method, and FIG. 3 is an explanatory drawing of an absorbing device for making a precursor of an electroconductive thin film formed by applying a liquid onto a substrate and drying it absorb the vapor of water or organic compound.

In FIG. 2, reference numeral 6 denotes a discharge head provided with a discharge nozzle 7, reference numeral 8 denotes a substrate stage having a substrate 1 mounted thereon, reference numeral 9 denotes a control computer, reference numeral 10 denotes a mechanism for controlling and driving an ink jet, reference numeral 11 denotes a position detecting mechanism, and reference numeral 12 denotes a position on a substrate 1, to which a liquid is to be applied.

At first, a substrate 1 is sufficiently cleaning with a detergent, pure water and an organic solvent. Subsequently, a device electrode material is deposited on the substrate 1 by a vapor deposition method and a sputtering method, and device electrodes 2 and 3 of FIG. 1 are formed on the substrate 1, for instance, with a photolithographic technology. A liquid including a component material of an electroconductive thin film 4 is deposited on a substrate 1 by the steps of: mounting the substrate 1 having the device electrodes 2 and 3 formed thereon on a predetermined position of a substrate stage 8; and making a discharge nozzle 7 of a discharge head 6 arranged above the substrate 1 discharge the liquid to a position 12 on the substrate 1, to which the liquid is to be applied. It is preferable to apply the liquid onto the substrate 1 after having subjected the substrate 1 to water-repellence treatment so as to prevent the liquid from diffusing or flowing on the surface of the substrate 1.

The liquid to be applied onto the above described substrate 1 includes, for instance, a liquid having a metal or the like of a component of the above described electroconductive thin film 4 dissolved or dispersed in water or an organic solvent. The liquid also includes a solution of an organic metal containing the metal of the component of the electroconductive thin film 4.

Specifically, the liquid is, for instance, a solution having an organopalladium complex dissolved in a solvent of 75 wt. % water and 25 wt. % isopropyl alcohol.

In addition, a liquid application mechanism shown in FIG. 2 is kept preferably in an environment having a predetermined temperature, a predetermined humidity and a predetermined vapor pressure of an organic solvent while being controlled by an atmosphere controlling mechanism which is not shown in the drawings.

A device for applying a liquid is preferably an ink-jet type device.

An ink-jet type device includes a piezo type device and a heat-foaming (bubble jet (registered trademark)) type device. The above described piezo type device is one of an ink-jet type device and a device for forming and ejecting liquid droplets by using a deforming force of a piezoelectric member when voltage is applied to it. On the other hand, the above described bubble jet (registered trademark) type device is similarly one of an ink-jet type device and a device for forming and ejecting liquid droplets by using a power of bumping when a liquid is heated in a small space.

As described above, the above described solution or liquid dispersion is discharged through a discharge nozzle 7 placed on a discharge head 6 above the substrate 1 on a substrate stage 8 as droplets, and is deposited on a substrate 1. In the above step, the discharge head 6 discharges the droplets when the discharge head 6 (discharge nozzle 7) and the substrate 1 have made a predetermined positional relation controlled by a mechanism 10 for controlling and driving an ink jet, which co-operates with a position detecting mechanism 11 and a stage driving mechanism (not shown) installed on a substrate stage 8. A control computer 9 conducts a series of the controls. Thus, the ink-jet type device can deposit the droplets on a predetermined position 12 on the substrate 1, to which the droplets are to be applied. By the way, the discharge head 6 is provided with one or more discharge nozzles 7 for discharging the droplets.

After the liquid has been applied onto a substrate 1 as described above, the liquid is dried to form a precursor of an electroconductive thin film on the substrate 1.

Subsequently, the substrate 1 having the above described precursor of the electroconductive thin film formed thereon is charged into a chamber 13 of an absorbing device shown in FIG. 3. In the chamber 13, the precursor of the electroconductive thin film is exposed to an atmosphere of vaporized water or a vaporized organic compound, and absorbs the water or the organic compound in the atmosphere.

The chamber 13 may be made from any material as long as it reliably keeps airtightness, but is preferably made from stainless steel which has little risk of forming rust and easily secures sufficient strength, because the chamber 13 treats water or an organic compound. Reference numeral 14 denotes a substrate-importing entrance which is an opening for carrying a substrate 1 into the chamber 13 through a transport mechanism that is not shown in the drawings. In addition, reference numeral 15 denotes a substrate-exporting outlet which is an opening for carrying the substrate 1 out of the chamber 13 through the transport mechanism that is not shown in the drawings. The chamber 13 is provided with an atmosphere controlling mechanism 16 for monitoring the inner temperature and humidity and keeping them into predetermined values. In the above description, the humidity is a quotient where a pressure of the vapor (partial vapor pressure) of water or organic compound contained in the chamber at a certain temperature is divided by a saturated vapor pressure at the temperature.

A substrate 1 is carried into the chamber 13 through the above described substrate-importing entrance 14, and then the precursor of an electroconductive thin film on the substrate 1 is exposed to an atmosphere set to predetermined humidity in the chamber 13, and absorbs the vapor of water or organic compound.

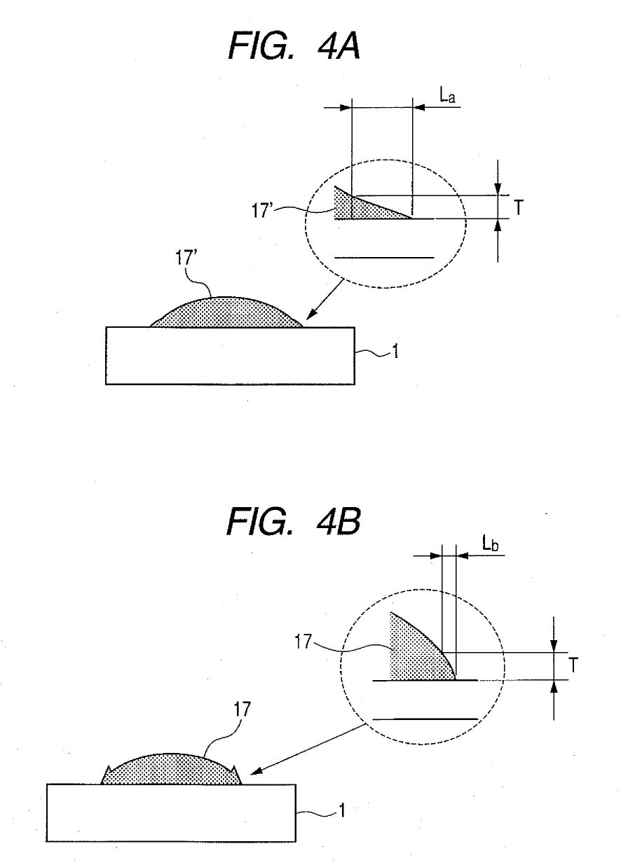

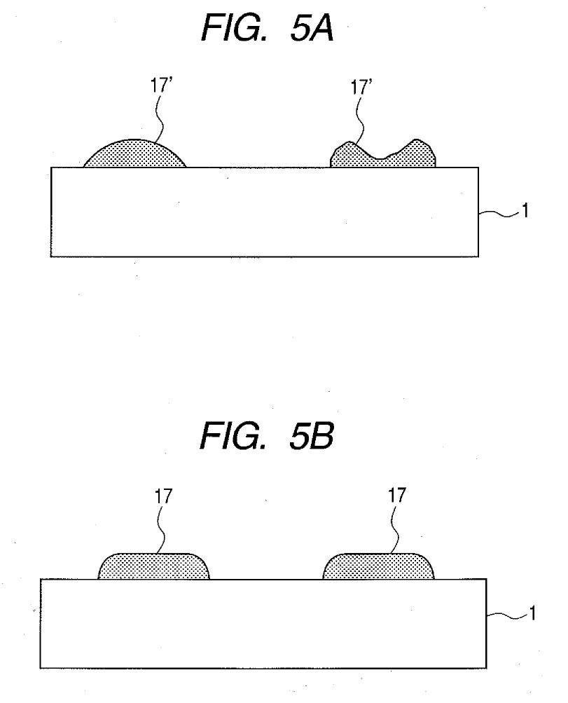

In the next place, an operation for arranging the periphery shape and the whole shape of the precursor of an electroconductive thin film into an appropriate form by making the precursor absorb the vapor of water or organic compound will be described with reference to FIGS. 4A, 4B, 5A and 5B.

FIGS. 4A and 4B explanatory drawings on an operation of arranging a periphery shape of the precursor of an electroconductive thin film into an appropriate form by making the precursor absorb the vapor of water or organic compound. FIG. 4A is an explanatory drawing on a cross-sectional shape of the precursor of an electroconductive thin film formed by applying a liquid onto a substrate and only drying it. FIG. 4B is an explanatory drawing on a cross-sectional shape of the precursor of an electroconductive thin film formed by steps of: applying a liquid onto a substrate, drying it and further making it absorb the vapor of water or organic compound in an atmosphere in which a partial pressure of the vapor is lower than the saturated vapor pressure. FIGS. 5A and 5B are explanatory drawings on an operation of arranging the whole shape of the precursor of an electroconductive thin film into an appropriate form by making the precursor absorb the vapor of water or organic compound. FIG. 5A is an explanatory drawing on an example of a cross-sectional shape of the precursor of an electroconductive thin film formed by applying a liquid onto a substrate and only drying it. FIG. 5B is an explanatory drawing on a cross-sectional shape of the precursor of an electroconductive thin film formed by the steps of: applying a liquid onto a substrate, drying it and further making it absorb the vapor of water or organic compound in an atmosphere in which a partial pressure of the vapor is close to the saturated vapor pressure.

At first, as shown in FIG. 4A, when a liquid on a substrate 1 is dried, a solvent or a dispersion medium in the liquid vaporizes, and a solid content remains to form a precursor 17′ of an electroconductive thin film. The precursor 17′ of the electroconductive thin film forms a smooth hemline in its perimeter via a process in which the solvent or the dispersion medium vaporizes and the liquid is dried.

A figure in a dashed circle line of FIG. 4A is a schematic block diagram of an enlarged shape for a periphery part of the precursor 17′ of an electroconductive thin film. Reference character La denotes the length of a thin region having a film thickness of T or smaller. When there is such an extremely thin region in a surface conduction electron-emitting device, the thin region causes a leakage current because of acquiring no fissure even through a fissure-forming process with the use of forming treatment.

On the other hand, when the precursor 17′ of an electroconductive thin film in FIG. 4A is subjected to an atmosphere having a partial pressure of the vapor of water or organic compound lower than the saturated vapor pressure and absorbs the vapor, the cross-sectional shape changes into such a cross-sectional shape of the precursor 17 of the electroconductive thin film as shown in FIG. 4B. The absorption provides an effect of improving the shape particularly in the periphery part. A figure in a dashed circle line in FIG. 4B shows a schematic block diagram of an enlarged shape for a periphery part of the precursor 17 of the electroconductive thin film, which has absorbed the vapor of water or organic compound. Reference character Lb denotes the length of a thin region having a film thickness of T or smaller. As is clear from FIG. 4A and 4B, it becomes possible to shorten the length of the thin region so as to satisfy La>Lb, by making the precursor 17′ of the electroconductive thin film absorb the vapor of water or organic compound to change it into the precursor 17 of the electroconductive thin film. The reason of the result is though to be because the precursor 17′ of the electroconductive thin film swells by absorbing the vapor and has arranged the cross-sectional shape into an appropriate form.

Any vaporizing component can be used for making the precursor 17′ of an electroconductive thin film absorb it as long as the component can swell the precursor 17′ of the electroconductive thin film when making the precursor absorb the vapor, but normally, water (steam) is used. In addition to water, such an organic compound can be used as ethanol, isopropyl alcohol, ethyleneglycol and diethylene glycol. When the organic compound is employed as the vaporizing component, the component is preferably an organic solvent particularly used in a liquid containing a component for forming a thin film.

When a partial pressure of the vapor of water or organic compound in an atmosphere for making the precursor 17′ of an electroconductive thin film exposed to itself is lower than the saturated vapor pressure to some extent, it is possible to change the shape only in the perimeter of the precursor 17′ of the electroconductive thin film, while maintaining the approximate shape of the precursor 17′ of the electroconductive thin film before being exposed to the atmosphere. As a partial pressure of the vapor of water or organic compound in an atmosphere for making the precursor 17′ of an electroconductive thin film exposed to itself approaches to the saturated vapor pressure, the whole shape of the precursor 17′ of the electroconductive thin film is arranged into an appropriate shape, and it becomes possible to uniformize the shape among a plurality of the precursors 17′ of the electroconductive thin film.

The operation of arranging the whole shape into an appropriate form according to the present invention will be further described with reference to FIGS. 5A and 5B.

As shown in FIG. 5A, when a liquid is dried, it forms a precursor 17′ of an electroconductive thin film having the shape of which the central part rises as in the left side of the figure or occasionally forms the precursor 17′ of the electroconductive thin film having the shape of which the central part is dented as in the right side of the figure. When these precursors 17′ of an electroconductive thin film are exposed to an atmosphere having a partial pressure of the vapor of water or organic compound close to the saturated vapor pressure, the shapes of both of the precursors are arranged into similar appropriate shapes having an approximately flat top face as shown in FIG. 5B. Accordingly, the cross-sectional shapes of the precursors 17′ of the electroconductive thin film forming different shapes while being dried as is shown in FIG. 5A can be uniformized as the precursor 17 of the electroconductive thin film as shown in FIG. 5B.

A partial pressure of the vapor of water or organic compound to be used in the present invention is preferably in a range of 20% to 99% by percentage with respect to the saturated vapor pressure. For information, the precursor 17 of an electroconductive thin film having the periphery shape or the whole shape arranged into an appropriate form by making the precursor absorb vapor keeps the arranged shape, even after the substrate has been taken out from a chamber 13 shown in FIG. 3 and water or an organic compound in the precursor has vaporized.

After the precursor 17 of an electroconductive thin film has been arranged as in the above description, the precursor 17 is heat-treated to eliminate the organic component contained in itself and to form an electroconductive thin film 4 described in FIGS. 1A and 1B. Then, the electroconductive thin film 4 is subjected to forming treatment to form an electron-emitting region 5 therein (cf. FIGS. 1A and 1B).

The electroconductive thin film 4 obtained by a method according to the present invention acquires a relationship of the above described La>Lb by reflecting a cross-sectional shape of an precursor 17 of an electroconductive thin film, consequently shortens the length of a region in which a fissure of an electron-emitting region 5 is hardly formed, and accordingly can minimize the generation of a leak current.

After the electroconductive thin film 4 has been subjected to forming treatment, the electroconductive thin film 4 is subjected to an activation operation of depositing carbon on an electron-emitting region 5 and/or the vicinity of it by applying voltage between device electrodes 2 and 3 in the presence of an organic gas, or is subjected to a stabilization operation of applying a higher voltage than a driving voltage between the device electrodes 2 and 3 in a high vacuum atmosphere, as needed. Through these steps, a surface conduction electron-emitting device having desired electron emission characteristics can be manufactured with a high degree of reproducibility.

### EMBODIMENTS

### Embodiment 1

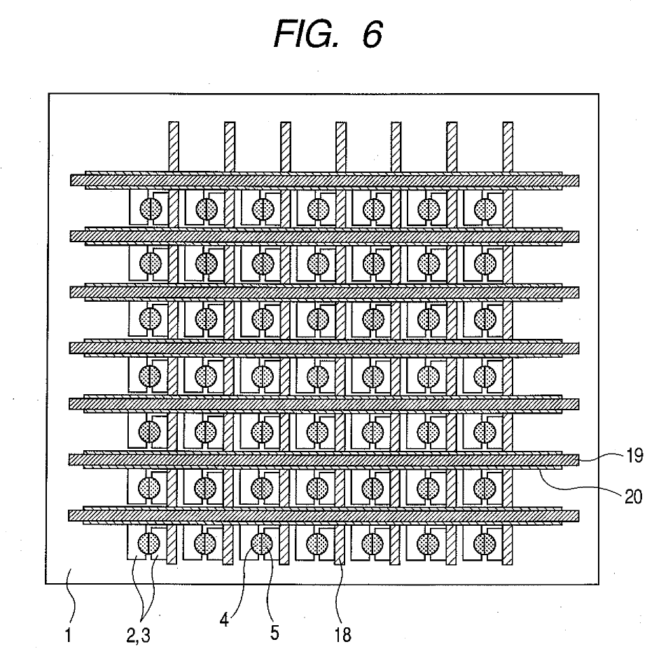

A substrate 1 was prepared which has a matrix form of wiring (column-directional wiring 18 and row-directional wiring 19) and device electrodes 2 and 3 formed thereon as shown in FIG. 6. The preparation procedure will be now described with reference to FIG. 6, FIG. 2 and FIG. 3.

(1) A glass substrate was employed as an insulating substrate 1; and was sufficiently cleaned with an organic solvent and was dried at 120° C. On the substrate 1, 172,800 pairs of device electrodes 2 and 3 each having an electrode width of 500 μm and a gap of 20 μm between the electrodes were formed into a matrix form of 240 rows and 720 columns from a Pt film, and respective device electrodes 2 and 3 were connected to respective wires. As the wiring, the matrix wiring was adopted consisting of the column directional wires 18 and the row directional wires 19, which are arranged so as to cross with each other through an interlayer-insulating layer 20.

(2) The above described substrate 1 was cleaned with an alkaline cleaning liquid and then was surface-treated with the use of a silane-based water-repellence agent.

(3) Subsequently, the above described substrate 1 was mounted on a substrate stage 8 in FIG. 2 by adsorption, which was placed in a chamber with a constant temperature and humidity set at a temperature of 25° C. and a humidity of 45%, and the liquid application position 12 was adjusted.

(4) A solution containing a component for forming an electroconductive thin film 4 was injected into a discharge head 6 as ink. An organopalladium-containing solution was used for the solution.

(5) A liquid was discharged onto the substrate 1 by sending an discharge signal to a discharge nozzle 6 at designed discharging timing through a position detecting mechanism 11 and a mechanism 10 for controlling and driving an ink jet, while scanning a substrate stage 8 in a +X direction. Thus, the organopalladium-containing solution was applied onto a space between device electrodes 2 and 3 and a part of them on a substrate 1.

(6) A liquid was dried on a substrate 1 at ordinary temperature to obtain a precursor 17′ of an electroconductive thin film. The substrate 1 having the precursor 17′ of the electroconductive thin film formed thereon was carried into a chamber 13 shown in FIG. 3, which was set at an atmosphere with a temperature of 25° C. and a humidity of 65%, was kept there for 5 minutes, and was returned to an atmosphere with a temperature of 25° C. and a humidity of 45%.

(7) Subsequently, the substrate 1 was heated at 350° C. for 30 minutes to form an electroconductive thin film 4 of palladium oxide thereon.

(8) The electroconductive thin film 4 was subjected to the forming treatment of applying voltage between device electrodes 2 and 3 to form an electron-emitting region therein, and further subjected to activation operation to impart high electron-emission efficiency to the electron-emitting region 5.

As a result of having evaluated the leak current in the electron-emitting device manufactured as described above, a ratio (If/Ith) was 1,500/1, where If is a current value when driving voltage is applied between the device electrodes 2 and 3 and Ith is a current when a half voltage of the driving voltage is applied to them. In contrast to this, the electron-emitting device prepared while skipping the above described treatment (6) showed the above described If/Ith of 150/1, which meant that the leak current was decreased to 1/10 in the present embodiment. As a result of manufacturing an image-forming apparatus through preparing a display panel by combining a face plate and a housing to an electron source substrate prepared as described above and further connecting a drive circuit to the display panel, the image-forming apparatus could be obtained at a high yield.

### Embodiment 2

In the present embodiment, an electron-emitting device was manufactured basically with the same method as in the case of Embodiment 1 except that an atmosphere in the chamber 13 used in the step (6) in Embodiment 1 was controlled to a temperature of 25° C. and a humidity of 80%.

As a result of having evaluated the uniformity of an obtained electron-emitting device by electric resistance in an electroconductive thin film 4, a coefficient of variation among all the devices was 3.0%. In contrast to this, a group of the electron-emitting devices manufactured while skipping absorption treatment in a chamber 13 in the present embodiment showed the coefficient of the variation of 10.0%, which means that the exposure treatment in a high-humidity atmosphere improved the uniformity by about 3.3 times. As a result of manufacturing an image-forming apparatus through preparing a display panel by combining a face plate and a housing to an electron source substrate prepared as described above and further connecting a drive circuit to the display panel, the image-forming apparatus having adequate uniformity could be obtained at a high yield.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-351375 filed on Dec. 6, 2005 which is hereby incorporated by reference herein in its entirety.

What is claimed is:

1. A method of forming a thin film comprising steps of:
applying on a substrate a liquid containing a component for forming a thin film;
drying the liquid to form a precursor of the thin film; and
heating the precursor to form the thin film, wherein
the heating step is conducted after absorbing of vapor of water into the precursor.

2. The method of forming a thin film according to claim 1 wherein the absorbing into the precursor vapor of water is conducted to swell the precursor.

3. The method of forming a thin film according to claim 1 wherein the applying the liquid is conducted by an ink jet method.

4. A method of forming an electron-emitting device comprising an electron-emitting area comprising steps of:
preparing a thin film according to claim 1; and
forming the electron-emitting area in the thin film.

5. A method of forming an organic electroluminescent device comprising a color filter comprising steps of:
preparing a thin film according to claim 1; and
forming the color filter in the thin film.

6. A method of forming a thin film comprising steps of:
applying on a substrate a liquid containing a component for forming a thin film;
drying the liquid to form a precursor of the thin film; and
heating the precursor to form the thin film, wherein
the heating step is conducted after absorbing of vapor of an organic compound into the precursor.

7. The method of forming a thin film according to claim 6 wherein the absorbing into the precursor vapor of organic compound is conducted to swell the precursor.

8. The method of forming a thin film according to claim 6 wherein the organic compound is an organic solvent.

9. The method of forming a thin film according to claim 6 wherein the applying the liquid is conducted by an ink jet method.

10. A method of forming an electron-emitting device comprising an electron-emitting area comprising steps of:
preparing a thin film according to claim 6; and
forming the electron-emitting area in the thin film.

11. A method of forming an organic electroluminescent device comprising a color filter comprising steps of:
preparing a thin film according to claim 6; and
forming the color filter in the thin film.
